(19) United States
(12) Patent Application Publication
(10) Pub. No.: US 2025/0275558 A1
(43) Pub. Date: Sep. 4, 2025

(54) SYSTEM AND METHOD FOR THE PRODUCTION OF PLANT PRODUCTS AS SUBSTITUTES FOR PASTA

(71) Applicant: INDUSTRIE ROLLI ALIMENTARI S.P.A., Roseto Degli Abruzzi (IT)

(72) Inventor: Gian Paolo ROLLI, Felino, Frazione S. Michele Di Tiorre (IT)

(21) Appl. No.: 18/858,994

(22) PCT Filed: Apr. 22, 2022
(86) PCT No.: PCT/IT2022/000018

§ 371 Date: Oct. 22, 2024

(51) Int. Cl. A23L 19/00; A23B 7/005; A23B 7/04; A23L 19/10; A23L 31/00

(52) U.S. Cl. CPC A23L 19/03; A23B 7/005; A23B 7/0408; A23L 19/10; A23L 31/00

(57) ABSTRACT

A system for the production of plant products as substitutes for pasta, which includes at least one carousel provided with at least one seat for stably accommodating at least one plant; rotations of the carousel are adapted for temporary alignment with perimetric stations thereof. At least one first perimetric station of the carousel includes elements configured to transfer the at least one plant onto the seat; at least one second perimeter station has a component configured to transversely cut the at least one plant (longitudinal partitioning according to predefined shapes and sizes); at least one third station includes elements configured to longitudinally cut the at least one plant arranged on the seat, in order to provide plant products as substitutes for pasta.

### CROSS-REFERENCE TO RELATED APPLICATIONS

This application is a 35 U.S.C. § 371 National Stage patent application of PCT/IT2022/000018, filed on 22 Apr. 2022, the disclosure of which is incorporated herein by reference in its entirety.

### TECHNICAL FIELD

The present disclosure relates to a system and a method for the production of plant products as substitutes for pasta. The plant products will be obtained through specific processing carried out on specific plant matrices which will be identified below.

### BACKGROUND

The consumption of pasta is very widespread internationally: this foodstuff however, given the high carbohydrate content, is prohibited in some diets and food plans which are aimed at encouraging slimming or at achieving specific health objectives or at reducing body fat percentage. Furthermore, all persons who suffer from coeliac disease cannot consume ordinary pasta, but instead have to resort to specific gluten-free formulations.

To this must be added the fact that a considerable proportion of the world's population is moving toward a vegan diet, and the presence of food additives of animal origin in traditional pasta makes such pasta unsuitable for anyone following a vegan diet.

In order to consume pasta, it must first be cooked and a sauce is then added (although the possibility is not ruled out of combined cooking, together with the sauce): the combination of pasta and condiment sauce is the food intended to be eaten by a user.

All these factors lead the market to identify alternative products to pasta, which can substitute it and which do not present the drawbacks described above.

### SUMMARY

The aim of the present disclosure is to solve the above mentioned drawbacks, by providing a system for the production of plant products as substitutes for pasta that makes it possible to provide products with a low calorific content.

Within this aim, the disclosure provides a system for the production of plant products as substitutes for pasta that best exploits and maximizes the raw materials used.

Another feature of the disclosure is to provide a plant product as a substitute for pasta with low calorific content.

Another object of the disclosure is to provide a plant product as a substitute for pasta that is rich in plant fibers.

The disclosure also provides a plant product as a substitute for pasta that is rich in vitamins typical of plants.

The disclosure further provides a plant product as a substitute for pasta that is rich in micro-nutrients typical of plants.

Another advantage of the disclosure is to provide a plant product as a substitute for pasta with minimal carbohydrate content.

The disclosure provides a plant product as a substitute for pasta that is gluten-free.

Another feature of the disclosure is to provide a plant product as a substitute for pasta that is suitable for consumption by vegans, therefore free from additives of animal origin.

The disclosure provides a method for the production of plant products as substitutes for pasta that is simple to carry out.

The disclosure also provides a method for the production of plant products as substitutes for pasta that is adapted to be applied on a plurality of different raw materials, without the need to use cereal flours.

The disclosure further provides a method for the production of plant products as substitutes for pasta is to have the possibility to produce pasta in the event of a shortage of cereals, determined by unfavorable climate conditions (for example the climate changes we have witnessed in recent years) or of events unforeseen at the time of planning (for example the outbreak of war), which could affect food stocks worldwide.

The present disclosure advantageously provides a system and a method for the production of plant products as substitutes for pasta which are of low cost, easily and practically implemented, and safe in use.

This aim and these and other advantages which will become better apparent hereinafter are achieved by providing a system for the production of plant products as substitutes for pasta, characterized in that it comprises at least one carousel provided with at least one seat for stably accommodating at least one plant, the rotations of said carousel being adapted for temporary alignment with perimetric stations of said carousel,
and in that:
at least one first perimetric station of said carousel comprises means configured to transfer said at least one plant onto said seat,
at least one second perimetric station of said carousel comprises means configured to transversely cut said at least one plant arranged on said seat, for the longitudinal partitioning according to predefined shapes and sizes of said at least one plant;
at least one third perimetric station of said carousel comprises means configured to longitudinally cut said at least one plant arranged on said seat, in order to provide said plant products as substitutes for pasta.

Such aim and such advantage are also achieved by providing a method for the production of plant products as substitutes for pasta, in which at least one plant is first obtained and washed, and which includes the following steps:
transversely cutting said plant into pieces of predefined length;
longitudinally cutting said pieces, providing units with a predefined cross-section and length;
subjecting such units to at least one subsequent operation chosen from among at least one thermal treatment, an additive with at least one food substance, a packaging, and combinations thereof.

Such aim and such advantages are also achieved by providing a plant product as a substitute for pasta, characterized in that is obtained by way of the subdivision of a plant into pieces of predefined shape and size evoking those of a preset pasta format, said plant being chosen from vegetables, tubers, root crops and fungi.

### BRIEF DESCRIPTION OF THE DRAWINGS

Further characteristics and advantages of the disclosure will become better apparent from the detailed description that follows of a preferred, but not exclusive, embodiment of the system and of the method for the production of plant products as substitutes for pasta, which is illustrated by way of non-limiting example in the accompanying drawings wherein:

FIG. 1 is a schematic view from above of a possible embodiment of a carousel of a system for the production of plant products as substitutes for pasta according to the disclosure;

FIG. 2 is a schematic perspective view of a possible set of blades for longitudinally cutting the plants of the carousel of FIG. 1;

FIG. 3 is a schematic perspective view of some plant products as substitutes for pasta according to the disclosure; and

FIG. 4 is a schematic perspective view of a further set of blades for longitudinally cutting the plants of the carousel of FIG. 1.

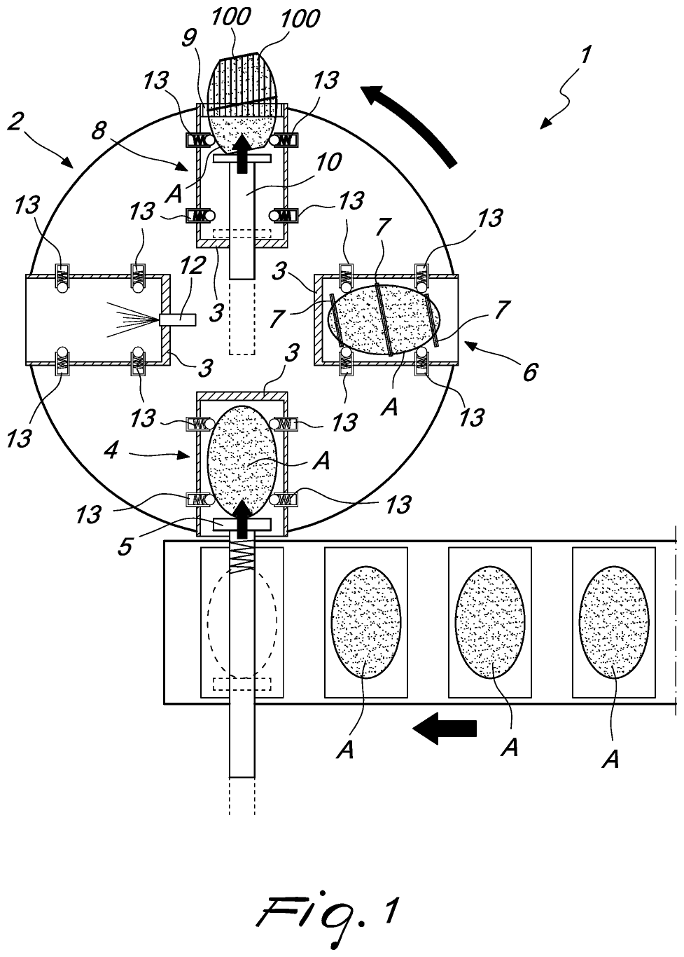

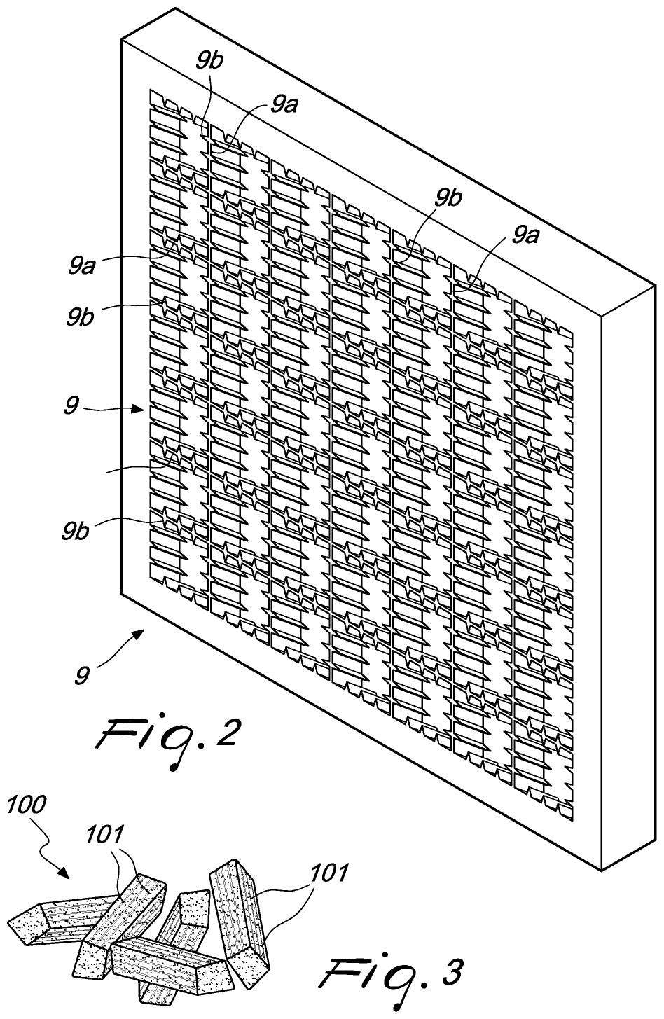

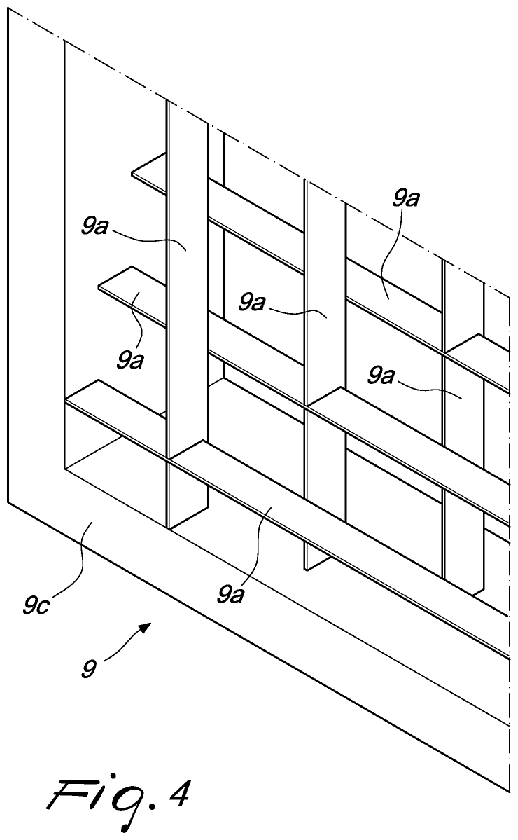

### DETAILED DESCRIPTION OF THE DRAWINGS

With reference to the figures, the reference numeral 1 generally designates a system for the production of plant products 100 as substitutes for pasta.

The system 1 according to the disclosure can profitably comprise at least one carousel 2 provided with at least one seat 3 for stably accommodating at least one plant A.

The rotations of the carousel 2 will conveniently be adapted for temporary alignment with operational perimetric stations.

At least one first perimetric station 4 of the carousel 2 will advantageously comprise means 5 configured to transfer at least one plant A onto a seat 3.

The transfer means 5 can conveniently be constituted by an actuated pusher, which will be configured to intercept the plant A (from a magazine or from a transit zone) and push it (translating it) onto the seat 3 with which the pusher is aligned.

According to the disclosure there is furthermore at least one second perimetric station 6 perimetral with respect to the carousel 2 which can advantageously comprise means 7 configured to transversely cut the at least one plant A arranged on the respective seat 3. This will determine the longitudinal partitioning of the plant A according to predefined shapes and sizes.

The means 7 configured for cutting can be knives (blades) which are moved with a linear motion in a transverse direction with respect to the plant: such direction is preferably inclined with respect to the longitudinal axis of the plant, so as to provide pieces of plant A of predefined length which have at least one end shaped like a wedge.

The carousel 2 is further provided with at least one third perimetric station 8, which comprises means 9 and 10 configured to longitudinally cut the at least one plant A (or rather the pieces of plant of predefined length) arranged on the seat 3, for the provision of plant products 100 as substitutes for pasta (constituted by units of predefined length and transverse dimensions which can, preferably, have at least one end shaped like a wedge).

The means 9 and 10 configured for longitudinal cutting are constituted preferably by a set 9 of blades 9a and by a presser 10.

The set 9 of blades 9a will be arranged according to a predefined pattern, defining kind of grille through which the plant A (or rather the corresponding pieces of predefined length) will be extruded, so that it can be cut into units of predefined transverse size.

The set 9 of blades 9a can be constituted (in a possible embodiment) by a grille in which the blades 9a constitute the crossed members.

This grille can be perpendicular to the longitudinal axis of the plant or inclined with respect to it. This second (inclined) embodiment offers the advantage of providing (in the step of extrusion of the plant A through it) a progressive cut (first the blades 9a of the nearer part of the grille will encounter the surface of the plant A and, as the plant advances, the other blades will come into contact as well) thus preventing damage to the plant which could compromise the quality of the plant products 100 being provided.

The possibility is not ruled out of providing a set 9 of blades 9a in which the blades are supported by a respective frame 9c on different planes: some blades 9a will be closer to the plant A (to the seat 3 that accommodates it) and others will instead be set further back. Using this distribution of blades 9a as well, it will be possible to carry out a progressive cutting of the plant, in which the blades 9a closest to it will be the first to cut into the surface and in which the further, farther-away blades 9a will progressively come into contact with it as the presser 10 translates the plant A toward them (in order to extrude it and cut it transversely according to the predefined norms).

In this second embodiment, observing the set 9 of blades 9a from the front, it will be noted that it defines regular free openings (corresponding to the final dimensions specified for the plant product 100), while on observing it from the side it will be possible to see that the blades 9a are located on offset planes, being distributed along a section of predefined length.

This specific embodiment offers the advantage of optionally being able to substitute a single blade 9a, in the event of damage to it, instead of having to replace the entire grille.

It should furthermore be noted that each blade 9a can comprise lateral toothing 9b which is designed to make incisions on the lateral surface of the plant product 100 (during extrusion such lateral toothing 9b will penetrate the surface of the plant A, leaving a groove).

Surface incisions on the plant product 101 have many functions.

Firstly such incisions 101 ensure a better adhesion of the sauce used as a condiment for the plant products 100 during their use (in a manner entirely similar to what already happens for traditional pasta of the “rigato” type, i.e. with a ridged surface).

Furthermore the incisions 101 increase the lateral surface of the plant products 100: during the cooking operations, this greater surface will enable a faster penetration of heat and therefore will speed up the cooking.

Since the plant product 100 is preferably (but not exclusively) intended to be frozen (and sold frozen), the incisions 101 will also be such as to prevent the surfaces of the products 100 from sticking to each other, thus ensuring that they remain separate even when frozen, with the consequence that a superior organoleptic yield in subsequent cooking is assured.

With particular reference to an embodiment of undoubted practical and applicative interest, the carousel 2 can usefully comprise at least one fourth station 11, provided with apparatuses 12 for washing and cleaning, which will be used to remove residues of the plant A which are present on the seat 3 following the cutting operations.

It will be possible to have the apparatuses 12 dispense jets of water at high pressure and optionally also at high temperature; the possibility is not ruled out of using jets of steam and/or of combining the apparatuses 2 with the devices for mechanically removing residues, of the type of brushes and the like.

The system 1 according to the disclosure further comprises at least one assembly configured to freeze the substitute plant products and to package predefined quantities of them, optionally with other semi-finished additive products.

The possibility is not ruled out, furthermore, of having respective UV lamps, facing toward semi-finished and/or finished products and/or the respective packages and/or surfaces of the various stations of the system, for the sanitization of the corresponding surfaces.

Such set will be arranged downstream of the third station 8 of the carousel 9, so as to receive the extruded plant products 100 and subject them to freezing and packaging.

According to the specific types of foods that it is intended to market, each package can contain solely the frozen plant products 100 (in predefined amounts) or it can also contain condiment sauces so that the user can have a food product that is ready to use (exclusively to be subjected to a specific cooking process).

The possibility is not ruled out of interposing, between the third station 8 and the freezing and packaging assembly, a pre-cooking step (according to methods that are known in the food industry). By virtue of the heat treatment of the plant products 100 executed by the pre-cooking step, the food that will be packaged will also be quicker to cook, to the advantage of one of the most-felt needs of the end user (rapidity of preparation).

It should be noted that each seat 3 can advantageously comprise respective elements 13 adapted for immobilizing and centering the at least one plant A on the seat 3 proper.

The elements 13 can be simply constituted by actuated pistons (for example electrically or pneumatically actuated), although the possibility is not ruled out of adopting mobile clamps and/or jaws or other conventional elements.

It should be noted that the at least one plant A should preferably be chosen from vegetables, tubers, root crops and fungi.

The protection offered by the present disclosure also extends to a method for the production of plant products 100 as substitutes for pasta, in which in which at least one plant A is first obtained and washed.

According to the disclosure it will be necessary, during a first step, to transversely cut the plant A into pieces of predefined length.

Subsequently, in a second step, the pieces of plant A prepared previously will need to be cut longitudinally, thus providing units with a predefined cross-section and length. These units will constitute the plant products 100.

At this point, in a final step of the method according to the disclosure, such units can be subjected to at least one subsequent operation chosen from among at least one thermal treatment, an additive with at least one food substance, a packaging, and combinations thereof.

It should be noted that the longitudinal cutting operation in the second step of the method according to the disclosure is obtained by extrusion of the pieces of plant A through the set 9 of blades 9a distributed according to a predefined arrangement.

In this regard, instead of the transverse cuts in the first step of the method according to the disclosure, it should be noted that these cuts can conveniently be executed along a path that is inclined with respect to the longitudinal axis of the plant A, conferring a wedge shape on at least one of the ends of those pieces.

The present disclosure also extends its protection to include to a plant product 100 as a substitute for pasta, obtained by way of the subdivision of a plant A into pieces of predefined shape and size evoking those of a preset pasta format.

Such plant A will preferably be chosen from vegetables, tubers, root crops and fungi.

More specifically, such plant A will preferably be from carrots, of any variety, yam, manioc, beetroot, turnips, daikon, also known as LoBok, oca of Peru, parsnips, radishes, rutabaga, Jerusalem artichokes, zucchini, pumpkin, potatoes, sweet potatoes and the like.

Advantageously the present disclosure solves the above mentioned problems, by providing a system 1 for the production of plant products 100 as substitutes for pasta that makes it possible to provide products 100 with a low calorific content.

Conveniently the system 1 according to the disclosure best exploits and maximizes the raw materials (the plants A) used.

Efficiently the plant product 100 according to the disclosure is rich in plant fibers.

Effectively the plant product 100 according to the disclosure is rich in vitamins typical of plants.

Fruitfully the plant product 100 according to the disclosure is rich in micro-nutrients typical of plants.

Advantageously the system 1 according to the disclosure makes it possible to produce plant products A with minimal carbohydrate content.

Profitably the system 1 according to the disclosure makes it possible to produce plant products A that are gluten-free.

Usefully the plant product 100 as a substitute for pasta is therefore suitable for consumption by vegans, therefore free from additives of animal origin.

Profitably the method for the production of plant products 100 as substitutes for pasta is simple to carry out.

Positively the method according to the disclosure is adapted to be applied on a plurality of different raw materials, without the need to use cereal flours.

Conveniently the method according to the disclosure makes it possible to produce pasta in the event of a shortage of cereals, determined by unfavorable climate conditions (for example the climate changes we have witnessed in recent years) or of events unforeseen at the time of planning (for example the outbreak of war), which could affect food stocks worldwide.

Validly, the system 1 and the method according to the disclosure are easily and practically implemented and of low cost: such characteristics render the system 1, the method and the plant products 100 according to the disclosure innovations that are certain to be safe in use.

The disclosure, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

Where the technical features mentioned in any claim are followed by reference numerals and/or signs, those reference numerals and/or signs have been included for the sole purpose of increasing the intelligibility of the claims and accordingly, such reference numerals and/or signs do not have any limiting effect on the interpretation of each element identified by way of example by such reference numerals and/or signs.

1-10. (canceled)

11. A system for the production of plant products as substitutes for pasta, the system comprising at least one carousel provided with at least one seat for stably accommodating at least one plant, rotations of said carousel being adapted for temporary alignment with perimetric stations of said carousel, and wherein:
at least one first perimetric station of said carousel comprises means configured to transfer said at least one plant onto said seat;
at least one second perimetric station of said carousel comprises means configured to transversely cut said at least one plant arranged on said seat, for the longitudinal partitioning according to predefined shapes and sizes of said at least one plant; and
at least one third perimetric station of said carousel comprises means configured to longitudinally cut said at least one plant arranged on said seat, in order to provide said plant products as substitutes for pasta.

12. The system according to claim 11, further comprising at least one fourth perimetric station, provided with apparatuses for washing and cleaning, for removal of residues of the said plant which are present on said seat following cutting operations.

13. The system according to claim 11, further comprising at least one assembly configured to freeze the plant products and to package predefined quantities of said plant products, optionally with other semi-finished additive products.

14. The system according to claim 11, wherein said at least one seat comprises respective elements adapted for immobilizing and centering said at least one plant on said at least one seat.

15. The system according to claim 14, wherein said at least one plant is chosen from vegetables, tubers, root crops, and fungi.

16. A method for the production of plant products as substitutes for pasta, in which at least one plant is first obtained and washed, the method includes the steps of:
transversely cutting said at least one plant into pieces of predefined length,
longitudinally cutting said pieces, providing units with a predefined cross-section and length, and
subjecting such units to at least one subsequent operation chosen from among at least one thermal treatment, an additive with at least one food substance, a packaging, and combinations thereof.

17. The method according to claim 16, wherein said longitudinal cutting operation is obtained by extrusion of said pieces of plant through a set of blades distributed according to a predefined arrangement.

18. The method according to claim 16, wherein said cutting is executed along a path that is inclined with respect to a longitudinal axis of the plant, conferring a wedge shape on at least one of ends of said pieces.

19. A plant product as a substitute for pasta, obtained by a subdivision of a plant into pieces of predefined shape and size evoking those of a preset pasta format, said plant being chosen from vegetables, tubers, root crops and fungi.

20. The plant product according to claim 19, wherein said plant is chosen from carrots, of any variety, yam, manioc, beetroot, turnips, daikon, also known as LoBok, oca of Peru, parsnips, radishes, rutabaga, Jerusalem artichokes, zucchini, pumpkin, potatoes, and sweet potatoes.
